(19) United States
(12) Patent Application Publication
(10) Pub. No.: US 2020/0101979 A1
(43) Pub. Date: Apr. 2, 2020

(54) SYSTEM AND METHOD FOR AUTONOMOUS CONTROL OF A VEHICLE

(71) Applicant: GM GLOBAL TECHNOLOGY OPERATIONS LLC, DETROIT, MI (US)

(72) Inventors: Nikolai K. Moshchuk, Grosse Pointe (US); Kausalya Singuru, Troy, MI (US); David Andrés Pérez Chaparro, Ferndale, MI (US)

(21) Appl. No.: 16/145,664

(22) Filed: Sep. 28, 2018

(51) Int. Cl. B60W 40/114; G05D 1/00; G05D 1/02

(52) U.S. Cl. CPC B60W 40/114; G05D 1/0088; G05D 1/0212; G05D 2201/0213; B60W 2520/125; B60W 2520/06; B60W 2520/14

(57) ABSTRACT

An automotive vehicle includes an actuator configured to control vehicle steering, acceleration, or shifting, a sensor configured to provide signals indicative of a lateral distance between a current vehicle location relative to a desired path, and a controller. The controller is configured to, in response to a determination that the lateral distance exceeds a threshold, automatically control the actuator according to an interstitial path. The interstitial path is automatically defined by the controller, and is based on a b-spline defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location. The interstitial path is further optimized based on a cost function.

### INTRODUCTION

The present disclosure relates to vehicles controlled by automated driving systems, particularly those configured to automatically control vehicle steering, acceleration, and braking during a drive cycle without human intervention.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes at least one actuator configured to control vehicle steering, acceleration, or shifting, at least one sensor configured to provide signals indicative of a current vehicle location relative to a desired path, and a controller. The controller is configured to, in response to a determination that a lateral distance between the current vehicle location and the desired vehicle path exceeds a threshold, automatically control the at least one actuator according to an interstitial path between the current vehicle location and the desired vehicle path. The interstitial path is automatically defined by the controller. The interstitial path is based on a B-spline defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location. The interstitial path is further optimized based on a cost function.

In an exemplary embodiment, the interstitial path is further defined by a first heading boundary condition based on a current slip angle of the vehicle, and by a second heading boundary condition based on a heading of the desired path at the merge location.

In an exemplary embodiment, the cost function includes a first component based on change in curvature of the interstitial path, a second component based on arc length of the interstitial path, and a third component based on deviation of the interstitial path relative to the desired path.

In an exemplary embodiment, the cost function includes at least one calibrated weight parameter. In such embodiments, the vehicle may additionally include a human-machine interface, with the at least one weight parameter being defined based on a user input to the human-machine interface to customize performance.

A method of controlling a vehicle according to the present disclosure includes providing the vehicle with at least one actuator configured to control vehicle steering, acceleration, or shifting, at least one sensor configured to provide signals indicative of a current vehicle location relative to a desired path, and at least one controller in communication with the at least one actuator and the at least one sensor. The method additionally includes determining, via the at least one sensor, a lateral distance between the current vehicle location and the desired path. The method further includes, in response to the lateral distance exceeding a calibrated threshold, calculating, via the at least one controller, a B-spline defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location. The method also includes optimizing the B-spline, via the at least one controller, according to a cost function to define an interstitial path between the current vehicle location and the merge location. The method further includes controlling the at least one actuator, via the at least one controller, according to the interstitial path.

In an exemplary embodiment, the B-spline is further defined by a first heading boundary condition based on a current slip angle of the vehicle, and a second heading boundary condition based on a heading of the desired path at the merge location.

In an exemplary embodiment, the cost function includes a first component based on change in curvature of the interstitial path, a second component based on arc length of the interstitial path, and a third component based on deviation of the interstitial path relative to the b-spline.

In an exemplary embodiment, the cost function includes at least one calibrated weight parameter. Such embodiments may further include providing the vehicle with a human-machine interface, where the at least one weight parameter is defined based on a user input to the human-machine interface.

A control system for an autonomous vehicle according to the present disclosure includes a controller in communication with non-transient data memory provided with instructions to receive a sensor signal indicating a current vehicle location, and to determine a lateral distance between the current vehicle location and a desired path. In response to the lateral distance exceeding a calibrated threshold, a B-spline is defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location. The B-spline is optimized according to a cost function to define an interstitial path between the current vehicle location and the merge location. An actuator control signal is output to control at least one actuator according to the interstitial path.

Embodiments according to the present disclosure provide a number of advantages. For example, the present disclosure provides a system and method for autonomously controlling a vehicle to merge with a desired trajectory, and moreover does so via a method which may be customized according to user preferences, thereby increasing user satisfaction.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIGS. 3A and 3B are flowchart representations of a method of controlling a vehicle according to an embodiment of the present disclosure; and

FIG. 4 is an illustration of a vehicle being controlled according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

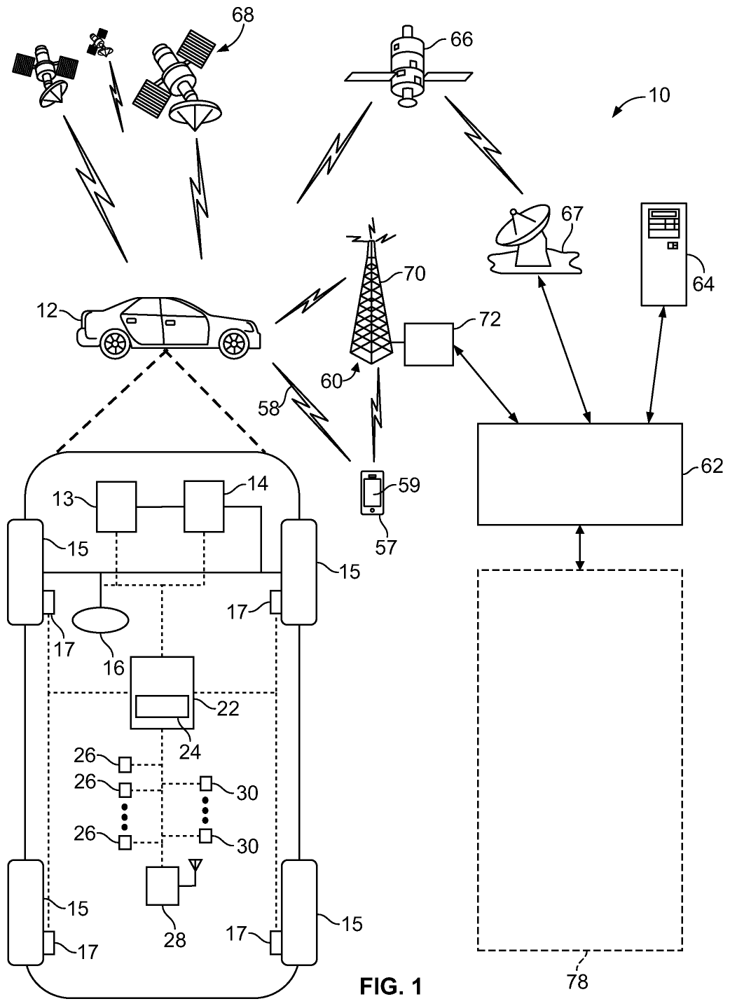

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Three automation system. A Level Three system indicates “Conditional Automation”, referring to the driving mode-specific performance by an automated driving system of all aspects of the dynamic driving task with the expectation that the human driver will respond appropriately to a request to intervene.

Other embodiments according to the present disclosure may be implemented in conjunction with so-called Level One or Level Two automation systems. A Level One system indicates “driver assistance”, referring to the driving mode-specific execution by a driver assistance system of either steering or acceleration using information about the driving environment and with the expectation that the human driver perform all remaining aspects of the dynamic driving task. A Level Two system indicates “Partial Automation”, referring to the driving mode-specific execution by one or more driver assistance systems of both steering and acceleration using information about the driving environment and with the expectation that the human driver perform all remaining aspects of the dynamic driving task.

Still other embodiments according to the present disclosure may also be implemented in conjunction with so-called Level Four or Level Five automation systems. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

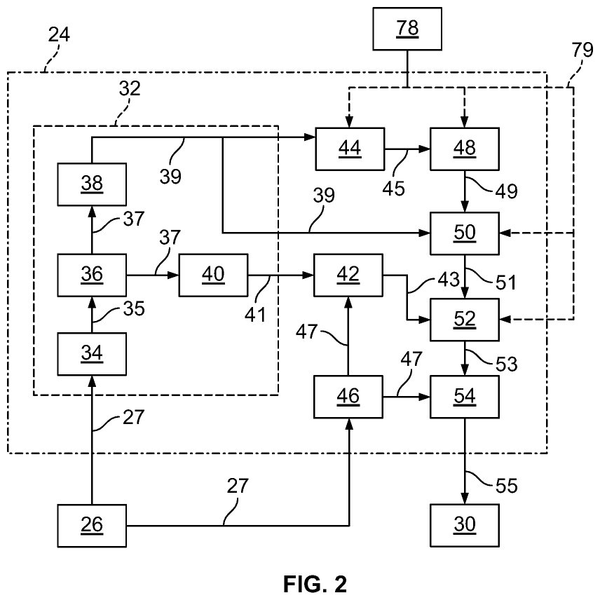

As shown in FIG. 2, the ADS 24 includes multiple distinct systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

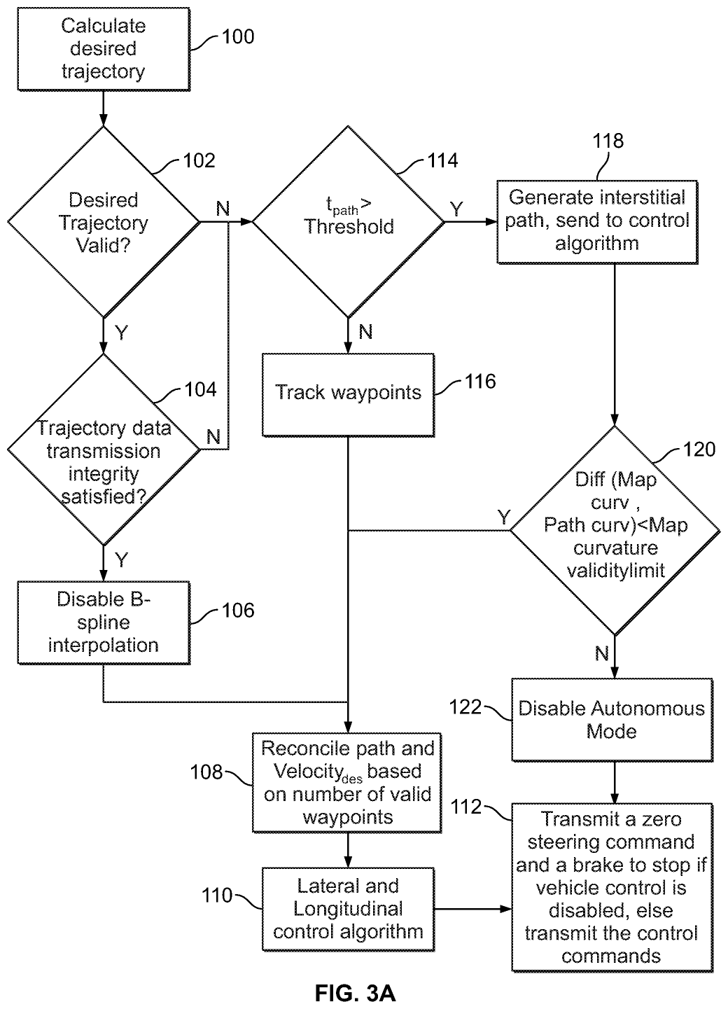

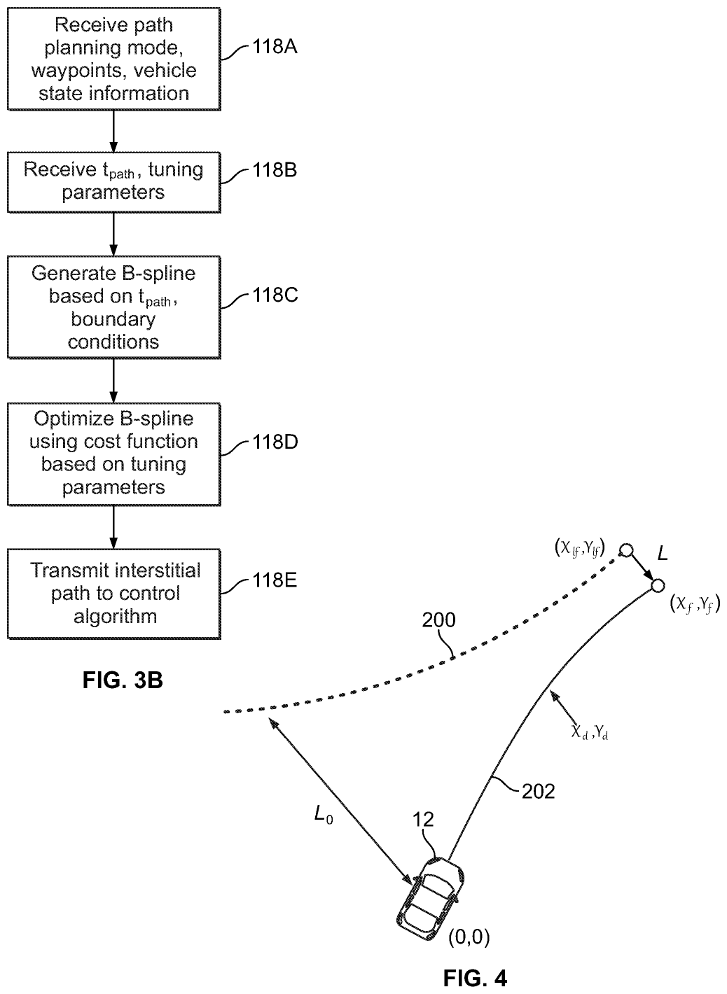

Under some operating conditions, a current location of the vehicle 12 may differ from the desired path calculated by the path planning module 50. This may occur, for example, subsequent an obstacle avoidance maneuver, when the vehicle is not centered in the current lane, or when a lane change is desired. In such circumstances, the ADS 24 should determine how to proceed from the current location to the desired path. A method for controlling a vehicle in such circumstances is described below and in conjunction with FIGS. 3A, 3B, and 4.

Referring now to FIG. 3A, a method of controlling a vehicle according to an embodiment of the present disclosure is illustrated in flowchart form. The algorithm begins at block 100 by calculating a desired trajectory. This may be performed, for example, by the path planning module 50 as discussed above. The desired trajectory comprises a plurality of discrete waypoints. In the illustration of FIG. 4, the desired trajectory is depicted at 200.

A determination is made of whether the desired trajectory is valid, as illustrated at operation 102. In an exemplary embodiment, the desired trajectory is classified as valid based on a validity flag. The validity flag may be established based on an evaluation performed by an external processor such as an integrity monitor, as part of an internal integrity check, or by any other suitable means.

In response to the determination of operation 102 being positive, control proceeds to operation 104 and a determination is made of whether the external trajectory satisfies a data transmission integrity check. In an exemplary embodiment, this is performed by evaluating the received trajectory for consistency over a temporal interval, e.g. 40 ms.

In response to the determination of operation 104 being positive, B-spline interpolation is disabled, as illustrated at operation 106.

The path and a desired velocity are reconciled, as illustrated at block 108, and conveyed to a lateral and longitudinal control algorithm, as illustrated at block 110. In an exemplary embodiment, the lateral and longitudinal control algorithm are part of the first control module 52 and/or vehicle control module 54 as discussed above.

The vehicle is controlled according to the control commands, as illustrated at block 112, in conjunction with an emergency braking algorithm.

Returning to operations 102 and 104, in response to a negative determination of either operation 102 or 104, control proceeds to operation 114. At operation 114, a determination is made of whether a time parameter tₚₐₜₕ exceeds a calibrated threshold. As will be discussed in further detail below, the time parameter tₚₐₜₕ is a parameter corresponding to an elapsed time of a calculated interstitial path between the current vehicle location and the desired trajectory. The parameter tₚₐₜₕ may be obtained from a lookup table or otherwise obtained as a function of a lateral distance between the current vehicle location and the desired trajectory.

In response to the determination of operation 114 being negative, i.e. tₚₐₜₕ does not exceed the calibrated threshold, the waypoints of the desired trajectory are maintained and tracked, as illustrated at block 116. Control then proceeds to block 108. Relatively small deviations from the desired path may thereby be disregarded.

In response to the determination of operation 114 being positive, i.e. tₚₐₜₕ does exceed the calibrated threshold, then an interstitial path is generated and sent to the control algorithm, as illustrated at block 118. This calculation will now be discussed in further detail with respect to block 118.

The path planning mode and waypoints of the desired trajectory are received, along with vehicle state information, as illustrated at block 118A. In an exemplary embodiment, the path planning mode is indicative of the desired maneuver type, e.g. maintaining the center of a current driving lane or executing a lane change. The waypoints may be based on various inputs such as map data, sensor data, or combinations thereof. The vehicle state information may include parameters such as longitudinal speed in a fore-aft direction of the vehicle, lateral speed in a side-side direction of the vehicle 12, road wheel angle, yaw rate of the vehicle 12, latitude and longitude of the vehicle 12, heading of the vehicle 12, other relevant parameters, or any suitable combination thereof.

Parameters for an interstitial path are then obtained, as illustrated at block 118B. The parameters include a time parameter tₚₐₜₕ and tuning parameters w₁ⱼ, w₂ⱼ, and w_{L}. The time parameter tₚₐₜₕ refers to an elapsed time of the interstitial path, and may be tuned to control the path performance. In an exemplary embodiment, is a function of a lateral distance L₀. As illustrated in FIG. 4, L₀ refers to the lateral distance between a current location of the vehicle 12, denoted as (0,0), and the desired vehicle trajectory 200. The tuning parameters w₁ⱼ, w₂ⱼ, and w_{L} will be discussed in further detail below. In an exemplary embodiment, the time parameter tₚₐₜₕ and tuning parameters w₁ⱼ, w₂ⱼ, and w_{L} are determined based on a user input, e.g. a user selection of a driving preference such as COMFORT, SPORT, etc. Such an input may be performed via a human-machine interface (“HMI”), such as a touchscreen display, in communication with the controller 24. In such embodiments, a plurality of tables containing values for w₁ⱼ, w₂ⱼ, and w_{L} and tₚₐₜₕ are provided in non-transient data storage in communication with the controller 22, and the controller 22 selects an appropriate table based on the user input. In other embodiments, the time parameter tₚₐₜₕ and tuning parameters w₁ⱼ, w₂ⱼ, and w_{L} are fixed values provided by the vehicle manufacturer.

As illustrated at block 118C, a first step to define an interstitial path between the current location and the desired trajectory includes defining a cubic B-spline path. A first end of the B-spline is located at a current position of the vehicle, denoted (0,0), at time t=0. The current position (0,0) is offset from the desired trajectory by a lateral distance L₀. A second end of the B-spline is located at a calculated position (x_{f}, y_{f}) relative to a waypoint (x_{lf}, y_{lf}) on the desired trajectory 200 at time t=tₚₐₜₕ. The position (x_{f}, y_{f}) is laterally offset from the waypoint (x_{lf}, y_{lf}) by a distance L. Depending on the desired maneuver, the distance L may be equal to zero or may be a non-zero value.

Because tₚₐₜₕ determines the elapsed time of the interstitial path, tₚₐₜₕ may be tuned to control the path performance. In an exemplary embodiment, tₚₐₜₕ is a function of L₀. In such embodiments, at least one table may be provided, e.g. in nontransient data storage associated with the controller 22, with a plurality of values of tₚₐₜₕ associated with corresponding values of L₀.

The B-spline is derived from the following boundary conditions:

$${x}_{d} {\vert}_{t = 0} = {y}_{d} {\vert}_{t = 0} = 0 \\ \frac{{dy}_{d}}{{dx}_{d}} {\vert}_{t = 0} = 0$$

$$\frac{{d}^{2} {y}_{d}}{{dx}_{d}^{2}} {\vert}_{t = 0} = \frac{{d}^{2} {y}_{l}}{{dx}_{l}^{2}} {\vert}_{t = 0} = {ρ}_{0}$$

$${x}_{d} {\vert}_{t = {t}_{path}} = {x}_{f}$$

$${y}_{d} {\vert}_{t = {t}_{path}} = {y}_{f} \\ \frac{{dy}_{d}}{{dx}_{d}} {\vert}_{t = {t}_{path}} = {ϕ}_{f}$$

$$\frac{{d}^{2} {y}_{d}}{{dx}_{d}^{2}} {\vert}_{t = {t}_{path}} = {ρ}_{f}$$

Two cubic B-splines, x_{d} and y_{d}, may then be generated, having the general form

C_{i,i+1}(u)=Σₖ₌₀ⁿN_{k,3}(u)*Pₖ for uᵢ≤u≤uᵢ₊₁

where N_{k,p} are the cubic basis functions and Pₖ are the control points.

The basis functions N_{i,p}(u) are defined as

$${N}_{i , 0} ( u ) = \{ \begin{matrix}1 , {u}_{i} \leq u \leq {u}_{i + 1} \\ 0 , otherwise\end{matrix} \\ {N}_{i , p} ( u ) = \frac{u - {u}_{i}}{{u}_{i + p} - {u}_{i}} * {N}_{i , p - 1} ( u ) + \frac{{u}_{i + p + 1} - u}{{u}_{i + p + 1} - {u}_{i + 1}} * {N}_{i + 1 , p - 1} ( u )$$

where p is the degree of the basis function.

The B-spline is thereby defined by a first location boundary condition at (0,0), a first heading boundary condition based on a slip angle of the vehicle 12 at (0,0), which may be expressed as atan(v_{y}/vₓ), a first curvature boundary condition is based on a vehicle trajectory curvature at (0,0), which may be expressed as (A_{y}/v²), a second location boundary condition at (x_{f}, y_{f}), a second heading boundary condition based on a heading of the desired trajectory 200 at (x_{lf}, y_{lf}), and a second curvature boundary condition is based on a curvature of the desired trajectory 200 at (x_{lf}, y_{lf}). These boundary conditions may be used to derive a unique closed form solution for six control points, which may in turn be interpolated to define a plurality of waypoints wp₁ through wp₍ₙ₋₁₎ of the B-spline.

As illustrated at block 118C, a second step to define the interstitial path includes optimizing the waypoints of the B-spline path using a cost function. In an exemplary embodiment, the cost function may be expressed as:

J=J_{curv}+J_{dev}+J_{length}

J_{curv} refers to a sum of curvature squares. This term seeks to reduce the change in curvature in the optimized path to make it smoother and reduce jerk and lateral acceleration when tracking it, and may be expressed as:

$${J}_{curv} = \frac{1}{2} {\sum }_{j = 2}^{j = n + 1} {{w}_{1 j} ( {y}_{j} - 2 {y}_{j - 1} + {y}_{j - 2} )}^{2}$$

J_{dev} refers to a deviation from the B-spline. This term is meant to decrease the deviation of the optimized path to the waypoints, and may be expressed as:

$${J}_{dev} = \frac{1}{2} {\sum }_{j = 2}^{j = n + 1} {{w}_{2 j} ( {y}_{j} - {y}_{j}^{wp} )}^{2}$$

J_{length} refers to a length of the path. This term aims to reduce the arc length of the optimized path, and may be expressed as:

$${J}_{length} = \frac{1}{2} {w}_{L} {\sum }_{j = 2}^{j = n - 1} {( {y}_{j} - {y}_{j - 1} )}^{2}$$

In this formulation, the unknowns are Y=[y₂, y₃, . . . yₙ₋₁], and the optimal solution is Y=arg min J(Y,xⱼ,yⱼ,wₚ). The critical points are dJ/dyⱼ=0, j=2, 3, . . . , n−1. The tuning parameters w₁ⱼ, w₂ⱼ, and w_{L} may be controlled to modify the optimization algorithm. The curvature variation weights w₁ⱼ may be modified to vary path smoothness, the deviation weights w₂ⱼ may be modified to vary the allowable deviation from the B-spline, and the path length weight w_{L} may be modified to vary the length of the path before convergence.

Because J is a quadratic function on yⱼ, dJ/dyⱼ=0 is a linear function on yⱼ. Therefore, the optimized path can be found by solving the linear system given by dJ/(dy_j)=0

The optimal solution reduces to solving the algebraic equation AY=B, with the solution Y=A⁻¹B. The non-zero elements of the matrices A and B may be expressed as:

A_{i,i-2}=w_{1,i+1}

A_{i,j-1}=−2w_{1,i+1}−2w_{1,i+2}−w_{L}

A_{i,i}=w_{1,i+1}+4w_{1,i+2}+w_{1,i+3}+w_{2,i}+2w_{L}

A_{i,i+1}=−2w_{1,i+2}−2w_{1,i+3}−w_{L}

A_{i,i+2}=w_{1,i+3}

Bⱼ=w_{2,j}yⱼ^{wp} j≠n−2, j≠n−1

Bₙ₋₁=w₂yₙ₋₁^{wp}−w_{1,n}yₙ^{wp}

Bₙ₋₂=w₂yₙ₋₂^{wp}+2(w_{1,n}+w_{1,n+1})yₙ^{wp}−w_{1,n+1}yₙ₊₁^{wp}+w_{L}yₙ^{wp}

The interstitial path thereby defined is then transmitted to the control algorithm, as illustrated at block 118E.

Returning to FIG. 3, a determination is made of whether the curvature of the interstitial path is less than a calibrated curvature limit, as illustrated at block 120. The curvature limit may be a calibrated value based on, e.g. road conditions, vehicle speed, other relevant parameters, or any suitable combination thereof.

In response to the determination of operation 120 being positive, i.e. the curvature limit is not exceeded, control proceeds to block 108 as discussed above. The interstitial path is thereby executed by the lateral and longitudinal control algorithm.

In response to the determination of operation 120 being negative, i.e. the curvature limit is exceeded, then autonomous control of the vehicle is discontinued, as illustrated at block 122. In embodiments having a human driver, this may comprise returning control of the vehicle to the human driver. In embodiments where no human driver is present, this may comprise executing a maneuver to place the vehicle in a safe condition, e.g. pulling to the side of the road or otherwise removing the vehicle from the flow of traffic. Control then proceeds to block 122 as discussed above.

As may be seen the present disclosure provides a system and method for autonomously controlling a vehicle to merge with a desired trajectory, and moreover does so via a method which may be customized according to user preferences, thereby increasing user satisfaction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
at least one actuator configured to control vehicle steering, acceleration, or shifting;
at least one sensor configured to provide signals indicative of a current vehicle location relative to a desired path;
at least one controller configured to, in response to a determination that a lateral distance between the current vehicle location and the desired vehicle path exceeds a threshold, automatically control the at least one actuator according to an interstitial path defined by the controller, the interstitial path comprising a B-spline defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location, the interstitial path being further optimized based on a cost function.

2. The vehicle of claim 1, wherein the interstitial path is further defined by a first heading boundary condition based on a current slip angle of the vehicle, and a second heading boundary condition based on a heading of the desired path at the merge location.

3. The vehicle of claim 1, wherein the cost function includes a first component based on change in curvature of the interstitial path, a second component based on arc length of the interstitial path, and a third component based on deviation of the interstitial path relative to the b-spline.

4. The vehicle of claim 1, wherein the cost function includes at least one calibrated weight parameter.

5. The vehicle of claim 4, further comprising a human-machine interface, wherein the at least one weight parameter is defined based on a user input to the human-machine interface.

6. A method of controlling a vehicle, comprising:
providing the vehicle with at least one actuator configured to control vehicle steering, acceleration, or shifting, at least one sensor configured to provide signals indicative of a current vehicle location relative to a desired path, and at least one controller in communication with the at least one actuator and the at least one sensor;
determining, via the at least one sensor, a lateral distance between the current vehicle location and the desired path;
in response to the lateral distance exceeding a calibrated threshold, calculating, via the at least one controller, a B-spline defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location;
optimizing the B-spline, via the at least one controller, according to a cost function to define an interstitial path between the current vehicle location and the merge location; and
controlling the at least one actuator, via the at least one controller, according to the interstitial path.

7. The method of claim 6, wherein the B-spline is further defined by a first heading boundary condition based on a current slip angle of the vehicle, and a second heading boundary condition based on a heading of the desired path at the merge location.

8. The method of claim 6, wherein the cost function includes a first component based on change in curvature of the interstitial path, a second component based on arc length of the interstitial path, and a third component based on deviation of the interstitial path relative to the b-spline.

9. The method of claim 6, wherein the cost function includes at least one calibrated weight parameter.

10. The method of claim 9, further comprising providing the vehicle with a human-machine interface, wherein the at least one weight parameter is defined based on a user input to the human-machine interface.

11. A control system for an autonomous vehicle, the control system comprising a controller in communication with non-transient data memory provided with instructions to:
receive a sensor signal indicating a current vehicle location;
determine a lateral distance between the current vehicle location and a desired path;
in response to the lateral distance exceeding a calibrated threshold, calculate a B-spline defined by a first position boundary condition at the current vehicle location, a second position boundary condition at a merge location relative to the desired vehicle path, a first curvature boundary condition based on a current vehicle yaw rate, and a second curvature boundary condition based on a curvature of the desired vehicle path at the merge location;
optimize the B-spline according to a cost function to define an interstitial path between the current vehicle location and the merge location; and
output an actuator control signal to control at least one actuator according to the interstitial path.
